(19) United States
(12) Patent Application Publication
(10) Pub. No.: US 2012/0015664 A1
(43) Pub. Date: Jan. 19, 2012

(54) METHOD AND APPARATUS FOR MITIGATING INTERFERENCE IN FEMTO CELL IN WIRELESS COMMUNICATION SYSTEM

(75) Inventor: Shuangfeng HAN, Suwon-si (KR)

(73) Assignee: SAMSUNG ELECTRONICS CO. LTD., Suwon-si (KR)

(21) Appl. No.: 13/180,806

(22) Filed: Jul. 12, 2011

(30) Foreign Application Priority Data
Jul. 15, 2010 (KR) 10-2010-0068353

(51) Int. Cl. H04W 72/04

(52) U.S. Cl. 455/452.1

(57) ABSTRACT

A method for mitigating interference by a femto Base Station (BS) in a wireless communication system including a macro BS is provided. The method includes receiving information about resources allocated for a channel measurement signal from the macro BS, measuring an UpLink (UL) power by detecting a channel measurement signal transmitted from at least one Mobile Station (MS) to the macro BS based on the received information, determining MSs whose UL powers are greater than or equal to a threshold, and transmitting identification information for the MSs to the macro BS.

### PRIORITY

This application claims the benefit under 35 U.S.C. §119(a) of a Korean Patent Application filed in the Korean Intellectual Property Office on Jul. 15, 2010 and assigned Serial No. 10-2010-0068353, the entire disclosure of which is hereby incorporated by reference.

### BACKGROUND OF THE INVENTION

1. Field of the Invention

The present invention relates to a method and apparatus for mitigating interference in a femto cell in a wireless communication system. More particularly, the present invention relates to a method and apparatus for significantly reducing uplink interference from Mobile Stations (MSs) connected to a macro Base Station (BS) and located adjacent to a femto BS.

2. Description of the Related Art

A femto cell is an extended concept of the traditional structure of a wireless communication system, such as a cellular network. In the femto cell, functions performed by several elements in the conventional cellular network infrastructure may be realized by a single low-cost device.

In order to use femto cells, femto Base Stations (femto BSs) such as Femto Access Points (FAPs) are installed, which provide network interfaces to users. The FAP is generally connected to a mobile operator core network by an x-Digital Subscriber Line (xDSL) connection to a Femto Gateway (FGW).

Femto cells are mainly employed in indoor living environments to provide broadband services such as mobile voice services and data services at lower cost compared with outdoor micro/macro cells. When femto cells are deployed in a macro cell-based network, interference should be taken into account. It is generally known that functions of FAPs, for example, functions such as power optimization and automatic scrambling code selection, may affect interference cancellation. Among various kinds of interference, frequency interference is related to many factors, and its problems are more significant when femto BSs use their own dedicated carriers (i.e., different carriers).

When a dedicated carrier assigned to a femto cell is used adjacent to the carrier used by a macro network and a Mobile Station (MS) may access the femto cell when it is located adjacent to the femto cell, an additional study is needed to evaluate the impact by the MS connected to the adjacent carrier while near the femto cell, because service degradation may occur. The service degradation depends on how low in power a signal from the macro BS is.

FIG. 1 illustrates an example of deployment of macro cells and femto cells according to the related art.

Referring to FIG. 1, multiple Femto Cells (FCs) are deployed inside and outside the service areas of Macro Cells (MCs) 100 and 102. Multiple femto cells 106, 108, and 110 are located adjacent to an MS 120 in communication with a macro BS 104 of the macro cell 100.

When a macro BS and femto BSs deployed inside and outside the service area of the macro BS use a co-channel, the following interference problems may occur.

As a specific example, the macro BS 104 and a femto BS 112 located very close thereto use a co-channel. In this case, the femto BS 112 may have a very limited effective service area for data services (including even voice services in some cases) due to the high-power signals received from the macro BS 104 using the co-channel.

As another example, a femto BS 114 located far away from the macro BS 104 compared with the femto BS 112, may cause an outage of effective services being provided to MSs connected to the macro BS 104 due to the low-level signals received from the macro BS 104 using the co-channel.

In addition, the MS 120, which is located far away from the macro BS 104 but located adjacent to the femto BS 106, may cause excessive interference to other MSs in the femto cell of the femto BS 106.

### SUMMARY OF THE INVENTION

Aspects of the present invention are to address at least the above- mentioned problems and/or disadvantages and to provide at least the advantages described below. Accordingly, an aspect of the present invention is to provide a method and apparatus for significantly reducing uplink interference from Mobile Stations (MSs) connected to a macro Base Station (BS) and located adjacent to a femto BS.

Another aspect of the present invention is to provide a method and apparatus for determining a possible interference MS based on various channel measurement signals.

Another aspect of the present invention is to provide a method and apparatus for enabling efficient resource scheduling by determining possible interference MSs by detecting signals transmitted from MSs.

Another aspect of the present invention is to provide a method and apparatus for efficiently mapping MSs to frequency-time resources by a BS.

Another aspect of the present invention is to provide a method and apparatus for transmitting and receiving messages necessary for an interference mitigation operation among a macro BS, a femto BS, and MSs.

In accordance with an aspect of the present invention, a method for mitigating interference by a femto BS in a wireless communication system is provided. The method includes receiving information about resources allocated for a channel measurement signal from the macro BS, measuring an UpLink (UL) power by detecting a channel measurement signal transmitted from at least one MS to the macro BS, based on the received information, determining MSs whose UL powers are greater than or equal to a threshold, and transmitting identification information for the MSs to the macro BS.

In accordance with another aspect of the present invention, a method for mitigating interference by a macro BS in a wireless communication system including a femto BS is provided. The method includes transmitting information indicating resources allocated for a channel measurement signal to the femto BS, receiving, from the femto BS, identification information for MSs, whose UL powers detected from the channel measurement signal by the femto BS are greater than or equal to a threshold, and allocating resources to the MSs according to a predefined resource allocation scheme.

In accordance with another aspect of the present invention, a femto BS apparatus for mitigating interference in a wireless communication system including a macro BS. The femto BS apparatus includes a receiver for receiving resource allocation information for a channel measurement signal from the macro BS, a controller for measuring an UL power by detecting a channel measurement signal transmitted from at least one MS to the macro BS, based on the resource allocation information, for determining MSs whose UL powers are greater than or equal to a threshold, and for determining to transmit identification information for the MSs to the macro BS, and a transmitter for transmitting the identification information for the MSs to the macro BS.

In accordance with another aspect of the present invention, a macro BS apparatus for mitigating interference in a wireless communication system including a femto BS is provided. The macro BS apparatus includes a transmitter for transmitting information indicating resources allocated for a channel measurement signal to the femto BS, and a controller for receiving, from the femto BS, identification information for MSs, whose UL powers detected from the channel measurement signal by the femto BS are greater than or equal to a threshold, and for allocating resources to the MSs depending on a predefined resource allocation scheme.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating deployment of macro cells and femto cells according to the related art;

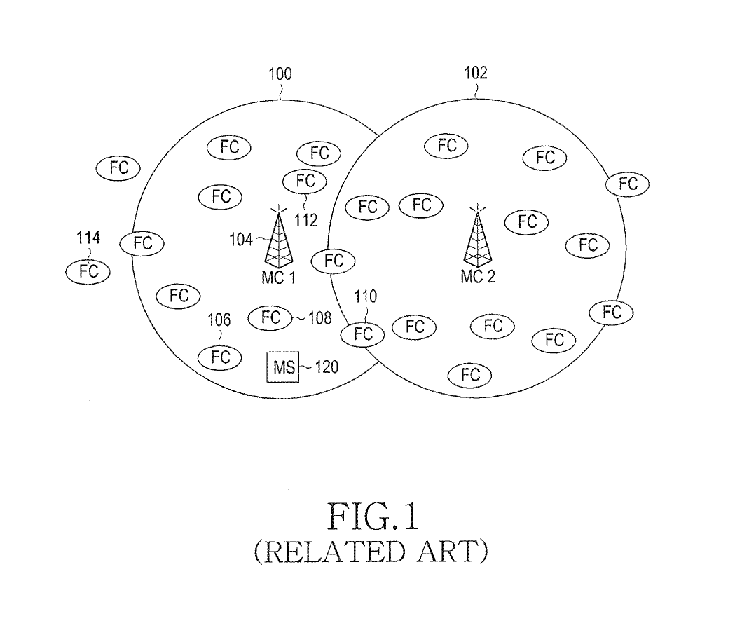

FIG. 2 is a diagram illustrating a signaling flow in an interference mitigation operation among a macro Base Station (BS), a femto BS, and Mobile Stations (MSs) according to an exemplary embodiment of the present invention;

FIG. 3 is a diagram illustrating a mapping relationship between possible interference MSs and frequency-time resource according to an exemplary embodiment of the present invention;

FIG. 4 is a flowchart illustrating an interference mitigation operation in a macro BS according to an exemplary embodiment of the present invention;

FIG. 5 is a flowchart illustrating an interference mitigation operation in a femto BS according to an exemplary embodiment of the present invention; and

FIG. 6 is a flowchart illustrating an interference mitigation operation in an MS according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist that understanding, but these are to be regarded as merely exemplary. Accordingly, those skilled in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

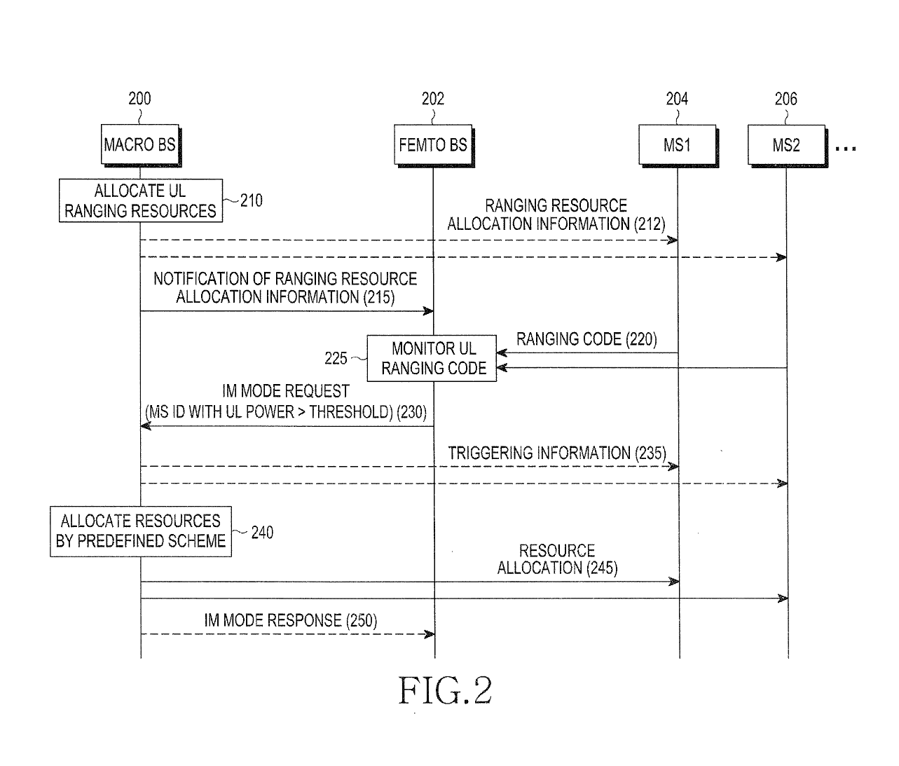

FIG. 2 illustrates a signaling flow in an interference mitigation operation among a macro Base Station (BS), a femto Base Station (BS), and Mobile Stations (MSs) according to an exemplary embodiment of the present invention.

Referring to FIG. 2, a femto BS 202 detects channel measurement signals transmitted from one or more MSs 204 and 206, and determines the MSs transmitting signals whose transmission powers are higher than a threshold as possible interference MSs based on the detected channel measurement signals. Examples of these channel measurement signals may include a ranging code and a sounding sequence transmitted by MSs. The ranging code used as a channel measurement signal, and the sounding sequence used as a channel measurement signal, will be described below.

A macro BS 200 allocates a portion of frequency-time resources for UpLink (UL) ranging as ranging resources to MSs registered in its cell in step 210, and may transmit the ranging resource allocation information to the MSs in step 212. Among the MSs in the cell, at least one MS desiring to perform ranging may transmit a ranging code to the macro BS 200 using the ranging resources. Optionally, a portion of the resources allocated by the macro BS 200 may be orthogonal with a frequency of resources used by the femto BS 202 deployed adjacent to the macro BS 200. The term ‘being adjacent to’ denotes signal sources located in a short distance such that their transmission/reception signals may serve as interference with each other. The criteria may be determined based on various factors including the system characteristics and the signal strength used in each BS. For example, the femto BS 202 may be determined to be adjacent to the macro BS 200, when they are located within a radius of 50 m from each other.

The macro BS 200 delivers the ranging resource allocation information to the femto BS 202 in step 215. The ranging resource allocation information is information about resources allocated for UL transmission of the ranging code. The femto BS 202 monitors UL ranging codes 220 transmitted from one or more MSs 204 and 206 based on the ranging resource allocation information, and detects and measures their UL powers in step 225. If the UL powers of the MSs 204 and 206, which were detected in the monitoring process for the ranging codes 220, are higher than a predetermined threshold, (i.e., if UL interference to the femto BS 202 is unallowable), the femto BS 202 may deliver a list of the detected MS Identifications (IDs) (e.g., a list of Advanced Mobile Station IDs (AMSIDs) which are ranging sequences or ranging codes used as MS IDs in a ranging process of the Institute of Electrical and Electronic Engineers (IEEE) 802.16 m system) to the macro BS 200 using an Interference Mitigation (IM) mode request message in step 230. The delivered MS IDs may be used when the macro BS 200 allocates resources to the detected MSs.

Optionally, the femto BS 202 may detect MSs causing interference even though the femto BS 202 uses sounding sequences instead of the ranging codes transmitted from the MSs. By receiving information indicating resources allocated for sounding signals from the macro BS 200, the femto BS 202 may obtain sounding sequence information and information (e.g., MS ID (or Station ID (STID)) used in a sounding process of the IEEE 802.16 m system) indicating which sounding sequence is allocated to which MS. Upon detecting the sounding sequences from the MSs 204 and 206, the femto BS 202 may determine STIDs and their associated UL powers. If the UL powers are greater than or equal to a predetermined threshold (i.e., if UL interference to the femto BS 202 is unallowable), the femto BS 202 delivers the pertinent MS IDs (i.e., STIDs) to the macro BS 200 in step 230. The delivered MS IDs may be used when the macro BS 200 allocates resources for the MSs.

An AMSID or STID list may be recorded in the femto BS 202 or the macro BS 200 in accordance with the following rules. MSs having higher interference with the femto BS 202 may have lower indexes, and MSs having lower interference with the femto BS 202 may have lower indexes. In recording MS IDs (AMSIDs or STIDs), it is possible to list MSs in order of high or low UL power detected for the MSs in the femto BS 202.

Table 1 shows an example of the written list of AMSIDs or STIDs.

TABLE 1

| idx 0 | idx 1 | idx 2 | idx 3 | idx 4 |
|---|---|---|---|---|
| ID 4 | ID 2 | ID 1 | ID 5 | ID 3 |

-------------> in ascending or descending order of power received in femto
BS

In the AMSID or STID list, AMSIDs or STIDs are arranged in ascending or descending order of power received in the femto BS 202. Optionally, as in Table 2 below, in recording the AMSID or STID list, it is possible to write UL powers of the MSs as well along with the MS IDs.

Table 2 shows another example of the written list of AMSIDs or STIDs.

TABLE 2

| idx 0 | idx 1 | idx 2 | idx 3 | idx 4 |
|---|---|---|---|---|
| ID 4, Power | ID 2, Power | ID 1, Power | ID 5, Power | ID 3, Power |
| 4 | 2 | 1 | 5 | 3 |

-------------> in ascending or descending order of power received in femto
BS

The macro BS 200 operating in an IM mode may inform the MSs 204 and 206 of the triggering of a predefined resource allocation scheme for the MSs 204 and 206 included in the AMSID (or STID) list in a Downlink (DL) in step 235. As another example, the macro BS 200 may inform all MSs whether the predefined resource allocation scheme is triggered, using 1-bit IDs included in DL data or control information. Upon receiving the IDs indicating the triggering, the MSs 204 and 206 operate in the IM mode.

In the IM mode, the macro BS 200 allocates resources to the MSs 204 and 206 whose detected UL powers are greater than or equal to the threshold in accordance with the predefined resource allocation scheme in step 240. The term ‘resource allocation’ denotes a process of allocating resources to the MSs serviced by the macro BS 200, including the MSs 204 and 206 whose detected UL powers are greater than or equal to the threshold.

The macro BS 200 informs the MSs 204 and 206 of the resource allocation information or the resource allocation results in step 245. Upon receiving the resource allocation information, the MSs 204 and 206 transmits and receives user data using the resources indicated by the resource allocation information.

Optionally, the macro BS 200 may transmit a response to the IM mode request from the femto BS 202 to the femto BS 202 in step 250. Optionally, the response may include an Acknowledge (ACK) or Negative Acknowledge (NACK) message. The response may also include information (i.e., resource allocation information) about resource allocation in the macro BS 200. The femto BS 202 may deliver information about resource allocation in the macro BS 200 to the MSs serviced by the femto BS 202, and the MSs may feed back channel measurement values for scheduling.

Various examples of allocating resources by the macro BS 200 in step 240 will be described in detail below.

The predefined resource allocation scheme is affected by the size of an AMSID (or STID) subset that is reported by the femto BS 202 to the MSs, whose UL powers are greater than or equal to a threshold. Assume that there are N MSs registered in the cell (i.e., macro cell), the number of AMSIDs (or STIDs) of MSs, whose UL powers detected by the femto BS 202 are greater than or equal to a threshold, is M, and one super frame includes F frames. If each of the frames is assumed to have S UL subframes in a Time Division Duplexing (TDD) system, the possible resource allocation schemes are as follows.

1) In case of resource allocation in a time-division mode, the macro BS 200 allocates M UL subframes having the full frequency band from N UL subframes, for the IM mode. F*S*(M/N) IM-mode UL subframes are allocated in one super frame.

2) In case of resource allocation in a frequency-division mode, the macro BS 200 allocates all UL subframes for the IM mode. However, all the UL subframes have a frequency bandwidth corresponding to a portion (approximately M/N) of the full frequency bandwidth.

3) In case of resource allocation in a frequency/time-division mode, the macro BS 200 allocates a portion (approximately M/N) of the total 2-dimensional (frequency/time) resources for the IM mode.

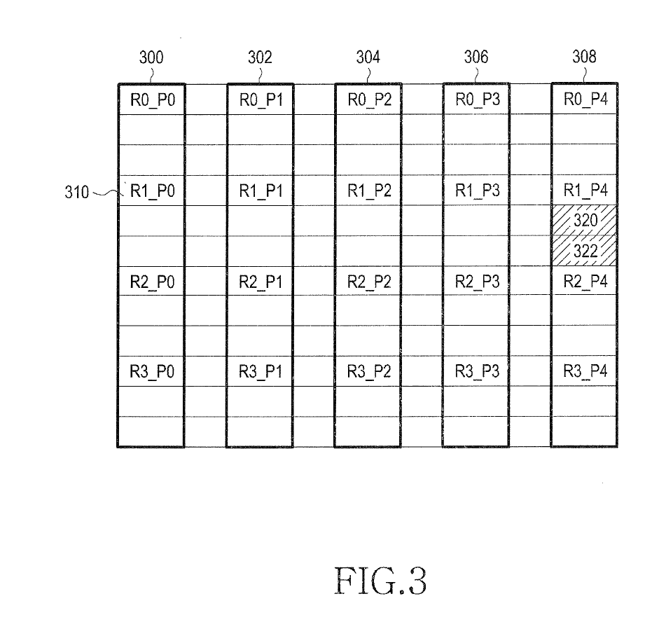

FIG. 3 illustrates a mapping relationship between possible interference MSs and frequency-time resource according to an exemplary embodiment of the present invention.

Referring to FIG. 3, Ri_Pj represents an i-th Resource Block (RB) of a j-th resource partition. For example, R1_P0 310 represents a 1^{st} resource block of a 0th resource partition.

Mappings between MS IDs (AMSIDs or STIDs) reported by the femto cell to possible interference MSs (i.e., MSs determined to have UL powers greater than or equal to a threshold) and associated frequency-time resources are defined depending on UL powers of the MSs. For example, the macro BS 200 (or the femto BS 202) uniformly partitions the allocated IM-mode two-dimensional frequency-time resources based on the number of reported MS IDs (AMSIDs or STIDs) for the possible interference MSs, and allocates the partitioned resource blocks located in j-th resource partitions 300, 302, 304, 306, and 308 to MS IDs (AMSIDs or STIDs) for the possible interference MSs with j-th indexes. When the resource partitions are allocated to MSs, the order of resource partitions may correspond to the order of MSs. In terms of the amount of interference, the MSs may be different in different resource partitions.

For example, assuming that resource partitions are allocated to MSs in the order of MSs with high UL power as in Tables 1 and 2, the amount of interference will be greatest when the femto BS 202 uses resource blocks located in the 0-th resource partition 300 as a co-channel, while the amount of interference will be less when the femto BS 202 uses resource blocks located in a resource partition (e.g., a resource partition 308) corresponding to a greater index. Accordingly, the femto BS 202 may determine in which partition the most serious interferer is allocated resources, making it possible to perform resource scheduling in which the impact of interference may be reduced more. The femto cell may mitigate interference by allocating the remaining resource blocks (e.g., resource blocks 320 and 322) located in the resource partition 308 having a low possibility of interference, to other MSs. Optionally, the femto BS 202 may use frequency-time resources, which are orthogonal in frequency with the frequency-time resources used in the macro BS 200.

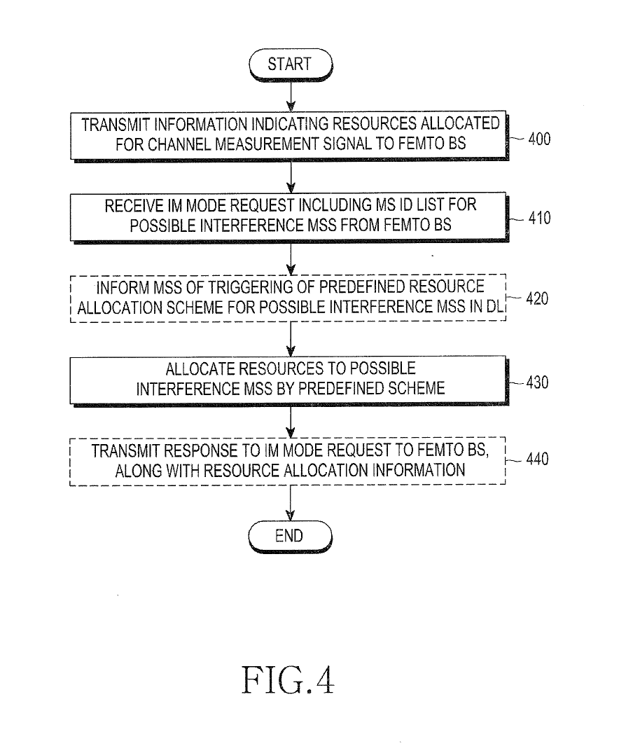

FIG. 4 illustrates an interference mitigation operation in a macro BS according to an exemplary embodiment of the present invention.

Referring to FIG. 4, the macro BS 200 transmits information indicating resources allocated for a channel measurement signal, to the femto BS 202 in step 400. The channel measurement signal may include a ranging code and a sounding sequence. The information for the channel measurement signal may be ranging channel allocation information for the ranging code, and may be information about resources allocated for a sounding sequence signal for the sounding sequence.

Upon receiving information indicating resources allocated for the channel measurement signal, the femto BS 202 detects the channel measurement signal based on the received information, and determines an MS, whose UL power is greater than or equal to a threshold, as a possible interference MS based on the detected signal. The macro BS 200 receives from the femto BS 202 an IM mode request including a list of MS IDs for the possible interference MSs in step 410.

Optionally, in performing resource allocation in the IM mode, the macro BS 200 may inform MSs of triggering of a predefined resource allocation scheme for the possible interference MSs in a DL in step 420.

The macro BS 200 performs the predefined resource allocation scheme on the possible interference MSs in step 430. The macro BS 200 may transmit the resource allocation information to the MSs.

Optionally, the macro BS 200 may transmit a response to the received IM mode request, along with the resource allocation information in step 440.

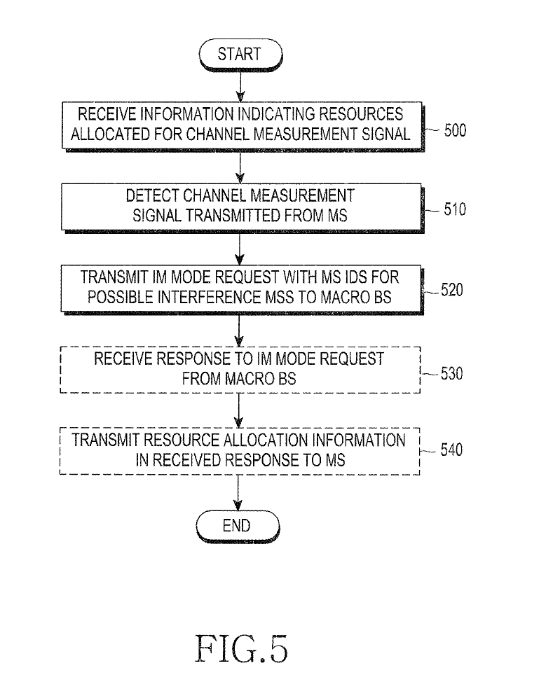

FIG. 5 illustrates an interference mitigation operation in a femto BS according to an exemplary embodiment of the present invention.

Referring to FIG. 5, the femto BS 202 receives information indicating resources allocated for a channel measurement signal from the macro BS 200 in step 500. The channel measurement signal may include a ranging code and a sounding sequence. The information for the channel measurement signal may be ranging channel allocation information, for the ranging code, and may be information about resources allocated for a sounding sequence signal, for the sounding sequence.

The femto BS 202 detects the channel measurement signal based on the information indicating resources allocated for the channel measurement signal in step 510. In the process of detecting the channel measurement signal, the femto BS 202 may treat MSs, whose UL transmission powers are greater than or equal to a threshold, as possible interference MSs.

The femto BS 202 transmits an IM mode request including MS IDs (e.g., AMSIDs or STIDs) for the possible interference MSs to the macro BS 200 in step 520.

Optionally, the femto BS 202 may receive a response to the IM mode request from the macro BS 200 in step 530. The response may include resource allocation information by the macro BS 200.

Optionally, the femto BS 202 may transmit the resource allocation information to the MSs being serviced by the femto BS 202 in step 540, to receive channel measurement feedbacks for the resources indicated by the resource allocation information from the MSs.

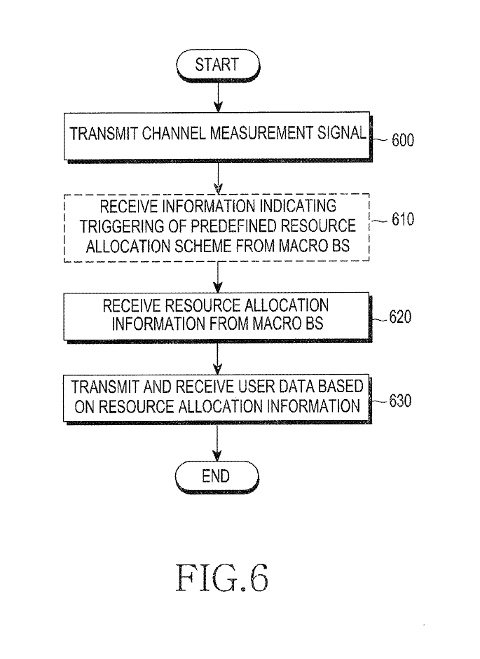

FIG. 6 illustrates an interference mitigation operation in an MS according to an exemplary embodiment of the present invention.

Referring to FIG. 6, the MS 204 (or 206) transmits a channel measurement signal to the macro BS 200 or the femto BS 202 in step 600. The channel measurement signal may include a ranging code and a sounding sequence.

Optionally, the MS 204 (or 206) may receive information indicating triggering of a predefined resource allocation scheme for interference mitigation from the macro BS 200 in step 610.

The MS 204 (or 206) receives information about the resources the macro BS 200 has allocated depending on the predefined resource allocation scheme, from the macro BS 200 in step 620.

The MS 204 (or 206) transmits and receives user data using the resources indicated by the resource allocation information in step 630.

A macro BS apparatus according to an exemplary embodiment of the present invention may include a controller for controlling the above-described interference mitigation operation in the macro BS, and a radio signal processor for processing the radio signals the controller has determined to transmit and receive. The controller controls the overall operation of the interference mitigation method described with reference to FIG. 4, and the radio signal processor inputs/outputs multiple messages and data the controller desires to transmit or receive.

A macro BS apparatus according to an exemplary embodiment of the present invention may include a controller for controlling the above-described interference mitigation operation in the macro BS, and a signal input/output unit for processing the radio signals the controller has determined to transmit and receive. The controller controls the overall operation of the interference mitigation method described with reference to FIG. 4, and the signal input/output unit inputs/outputs multiple messages and data the controller desires to transmit or receive.

A femto BS apparatus according to an exemplary embodiment of the present invention includes a controller for controlling the above-described interference mitigation operation in the femto BS, and a signal input/output unit for processing the radio signals the controller has determined to transmit and receive. The controller controls the overall operation of the interference mitigation method described with reference to FIG. 5, and the signal input/output unit inputs/outputs multiple messages and data the controller desires to transmit and receive.

An MS apparatus according to an exemplary embodiment of the present invention includes a controller for determining to transmit and receive multiple messages or signals to/from the macro BS or the femto BS, and a signal input/output unit for transmitting and receiving messages or signals to/from the macro BS or the femto BS under control of the controller. In other words, the MS operation in FIG. 6 may be realized by the controller and the signal input/output unit in the MS apparatus.

The apparatuses described above may include hardware and software components, and some components may be implemented as a combination of hardware and software components. However, it would be understood to a person of ordinary skill in the art that at least some components of the above-described apparatuses must be implemented at least partially in hardware in order for those components to carry out their function.

It should be noted that the operation and signal flow diagrams illustrated in FIGS. 2 and 4 to 6 are not intended to limit the scope of the present invention. The operations described in FIGS. 4 to 6 are mere examples of the operations performed in a controller of each apparatus, and it is to be noted that not all of the processes are mandatory and they should not necessarily be performed individually by certain operations or algorithms.

The above-described operations may be achieved by installing a memory unit storing related program codes in a certain component of the BS apparatus and/or the MS apparatus. In other words, the component of the BS apparatus and/or the MS apparatus may read out the program codes stored in the memory unit and execute them by means of a processor or a Central Processing Unit (CPU), thereby performing the above-described operations.

As is apparent from the foregoing description, a femto BS according to an exemplary embodiment of the present invention acquires information about MSs, whose possible interference to/from the femto BS is great, based on channel measurement signals, thereby mitigating interference of the femto BS based on the resource allocation information for the MSs and enabling efficient scheduling.

In addition, resource blocks for other MSs may be allocated to resource partitions which are not allocated to the possible interference MSs, enabling IM scheduling in a femto cell.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for mitigating interference by a femto Base Station (BS) in a wireless communication system including a macro BS, the method comprising:
receiving information about resources allocated for a channel measurement signal from the macro BS;
measuring an UpLink (UL) power by detecting a channel measurement signal transmitted from at least one Mobile Station (MS) to the macro BS, based on the received information;
determining MSs whose UL powers are greater than or equal to a threshold; and
transmitting identification information for the MSs to the macro BS.

2. The method of claim 1, further comprising:
receiving, from the macro BS, resource allocation information indicating information about resources which were allocated to the MSs according to a predefined resource allocation scheme; and
transmitting the resource allocation information for the MSs to MSs being serviced by the femto BS.

3. The method of claim 1, wherein the identification information for each of the MSs is recorded in the identification information for the MSs in ascending or descending order of the UL power,
wherein in the predefined resource allocation scheme, resource partitions generated by partitioning frequency-time resources are allocated to the MSs, and
wherein an order of the resource partitions corresponds to an order of MSs indicated by the identification information.

4. The method of claim 1, wherein, if the channel measurement signal is a ranging code, the identification information for the MSs is an Advanced Mobile Station IDentification (AMSID) for each of the MSs, and
wherein, if the channel measurement signal is a sounding sequence, the identification information for the MSs is a Station IDentification (STID) for each of the MSs.

5. A method for mitigating interference by a macro Base Station (BS) in a wireless communication system including a femto BS, the method comprising:
transmitting information indicating resources allocated for a channel measurement signal to the femto BS;
receiving, from the femto BS, identification information for Mobile Stations (MSs), whose UpLink (UL) powers detected from the channel measurement signal by the femto BS are greater than or equal to a threshold; and
allocating resources to the MSs according to a predefined resource allocation scheme.

6. The method of claim 5, further comprising:
transmitting resource allocation information indicating information about resources allocated for the MSs, to the femto BS.

7. The method of claim 5, wherein the identification information for each of the MSs is recorded in the identification information for the MSs in ascending or descending order of the UL power,
wherein the predefined resource allocation scheme allocates resource partitions generated by partitioning frequency-time resources to the MSs, and
wherein an order of the resource partitions corresponds to an order of MSs included in the identification information for the MSs.

8. The method of claim 5, wherein, if the channel measurement signal is a ranging code, the identification information for the MSs is an Advanced Mobile Station IDentification (AMSID) for each of the MSs, and
wherein, if the channel measurement signal is a sounding sequence, the identification information for the MSs is a Station IDentification (STID) for each of the MSs.

9. A femto Base Station (BS) apparatus for mitigating interference in a wireless communication system including a macro BS, the femto BS apparatus comprising:
a receiver for receiving resource allocation information for a channel measurement signal from the macro BS;
a controller for measuring an UpLink (UL) power by detecting a channel measurement signal transmitted from at least one Mobile Station (MS) to the macro BS, based on the resource allocation information, for determining MSs whose UL powers are greater than or equal to a threshold, and for determining to transmit identification information for the MSs to the macro BS; and
a transmitter for transmitting the identification information for the MSs to the macro BS.

10. The femto BS apparatus of claim 9, wherein, if the receiver receives, from the macro BS, resource allocation information indicating information about resources which were allocated to the MSs according to a predefined resource allocation scheme, the controller determines to transmit the resource allocation information for the MSs to MSs being serviced by the femto BS.

11. The femto BS apparatus of claim 9, wherein the controller records identification information for each of the MSs in ascending or descending order of the UL power,
wherein in the predefined resource allocation scheme, resource partitions generated by partitioning frequency-time resources are allocated to the MSs, and
wherein an order of the resource partitions corresponds to an order of MSs indicated by the identification information.

12. The femto BS apparatus of claim 9, wherein, if the channel measurement signal is a ranging code, the identification information for the MSs is an Advanced Mobile Station IDentification (AMSID) for each of the MSs, and
wherein, if the channel measurement signal is a sounding sequence, the identification information for the MSs is a Station IDentification (STID) for each of the MSs.

13. A macro Base Station (BS) apparatus for mitigating interference in a wireless communication system including a femto BS, the macro BS apparatus comprising:
a transmitter for transmitting information indicating resources allocated for a channel measurement signal to the femto BS; and
a controller for receiving, from the femto BS, identification information for Mobile Stations (MSs), whose UpLink (UL) powers detected from the channel measurement signal by the femto BS are greater than or equal to a threshold, and for allocating resources to the MSs depending on a predefined resource allocation scheme.

14. The macro BS apparatus of claim 13, wherein the controller controls the transmitter to transmit resource allocation information indicating information about resources allocated for the MSs, to the femto BS.

15. The macro BS apparatus of claim 13, wherein the identification information for the MSs, identification information for each of the MSs is recorded in ascending or descending order of the UL power, and
wherein the controller allocates resource partitions generated by partitioning frequency-time resources to the MSs so that an order of the resource partitions corresponds to an order of MSs included in the identification information for the MSs.

16. The macro BS apparatus of claim 13, wherein, if the channel measurement signal is a ranging code, the identification information for the MSs is an Advanced Mobile Station IDentification (AMSID) for each of the MSs, and
wherein, if the channel measurement signal is a sounding sequence, the identification information for the MSs is a Station IDentification (STID) for each of the MSs.
